(19) United States
(12) Patent Application Publication
(10) Pub. No.: US 2023/0146936 A1
(43) Pub. Date: May 11, 2023

(54) Defoliating device

(71) Applicant: ERO GMBH, SIMMERN (DE)

(72) Inventors: Jonas RETZMANN, KARBACH (DE); Dominik HENN, LOTZBEUREN (DE)

(21) Appl. No.: 17/916,582

(22) PCT Filed: Apr. 3, 2020
(86) PCT No.: PCT/DE2020/100279

§ 371 Date: Oct. 2, 2022

(51) Int. Cl. A01G 17/02; A01D 46/28

(52) U.S. Cl. CPC A01G 17/026; A01D 46/28

(57) ABSTRACT

A defoliating device (3) has at least two defoliating units (100, 200) which are located on the rear side of a common panel (7) of the device (3), the frontside surface of which panel faces a plant to be defoliated, , The panel (7) is provided with working openings (8, 9) or cut-outs, through which the defoliating units (100, 200), which are located on the rear side, act on the plants.The defoliating device (3) can be moved past the plants in a working direction, and where in each case two defoliating units (100, 200) having different ways of operating are arranged one behind the other in the working direction such that the units act sequentially on the plant region to be defoliated.

### RELATED APPLICATION

This application is a National Phase of PCT/DE2020/100279 filed on Apr. 3, 2020, the entirety of which is incorporated by reference.

### FIELD OF THE INVENTION

The invention relates to a defoliating apparatus having at least two defoliating units.

### BACKGROUND

Various devices and methods for defoliating fruit-bearing plants are known from the prior art. In particular in viticulture, it is conventional for the vines to be freed of excess or undesired foliage, which for instance conceals the grapes and shields them from solar irradiation, a certain amount of time before the grape harvest. Defoliation is also helpful both during a subsequent manual harvest, since fewer grapes are then concealed by leaves, and during a mechanical harvest, since in this case fewer leaves are included in the harvest.

To this end, defoliators/defoliating units are known, which are based on different modes of action, wherein usually either suction-air defoliators in the form of roller defoliators or compressed-air defoliators with preferably rotating compressed-air jets are used.

Thus, for instance DE 20 2006 003 135 U1 discloses a suction-air defoliator in the form of a roller defoliator, in which two rollers rotating in opposite directions, specifically a perforated roller and an unperforated, for example fluted roller, are arranged in parallel with a gap. A fan draws air in through the perforated roller and as a result pulls leaves into the gap, which are then plucked by the rotating rollers. DE 10 2008 018 640 A1 also discloses such a suction-air defoliator, but in that case the fan draws air in substantially through the roller gap and as a result pulls leaves into the gap.

A method for defoliating shrubs or vines using compressed air is disclosed for example by DE 25 49 066 A1. To that end, one or more compressed-gas jets are directed from the side toward a vine, wherein the compressed-gas jets are moved preferably in a normal plane with respect to the jet direction. The document proposes introducing compressed gas into pipe segments that are arranged in pairs, are driven in rotation and are provided with nozzles at their outer ends, said pipe segments rotating about an axis directed perpendicularly to a direction of travel along the vines. It is also possible for the plants or the canopy to be cleaned or dried by means of compressed air.

Of course, the different modes of operation of defoliating units each have advantages and disadvantages. Thus, the suction-air defoliators usually in the form of roller defoliators are particularly thorough when it comes to removing larger leaves and larger quantities of leaves, in particular from the outer side of the plant, but are less effective for instance with regard to small remnants of flowers or similar plant parts, which cover the grapes or fruits or stick to them and prevent or impair drying. Although compressed-air defoliators can remove such small plant parts, to remove larger leaves they require relatively high pressures or such strong pressure pulses that grapes or fruits could possibly be damaged by the actual pressure pulses or by plant parts accelerated by the pressure pulses. The working speed, that is to say the nominal speed at which a defoliator can be driven or guided past the plant, is also much higher in roller defoliators than for compressed-air defoliators.

There is therefore a conflict in the prior art that involves a need to balance the respective advantages and disadvantages of the treatment with regard to the particular plant state or a need to carry out a time-consuming double treatment first of all with one and then with the other defoliating method.

### SUMMARY OF THE INVENTION

Accordingly, the object of the present invention was to provide a defoliating apparatus with the aid of which both larger and smaller plant parts are removed reliably and accurately without damaging fruits and which allows a working speed that allows economically meaningful use in larger orchards or vineyards.

This object is achieved by the features of the main claim. Further advantageous developments are disclosed in the dependent claims.

Here, at least two defoliating units are arranged on the rear of a common plate of the defoliating apparatus, the front surface of which faces a plant to be defoliated, wherein the plate is provided with working openings or cutouts through which the defoliating units, arranged on the rear, act on the plant. The defoliating apparatus is movable in a working direction past the plant, and in each case two defoliating units with different modes of action are arranged in succession in the working direction such that they act sequentially, i.e. one after another, on the plant region to be defoliated.

Such a combination of two defoliating units with different modes of action reduces the working time compared with a separate use by about half and also makes it possible to use the different modes of action of the individual defoliating units synergistically.

This is the case in particular when, within the scope of an advantageous development, the first, in the working direction, of the two defoliating units arranged in succession is in the form of a suction-air defoliator and the second, in the working direction, of the two defoliating units arranged in succession is in the form of a compressed-air defoliator. There is already an advantage in that possible damage to the fruit, berries or grapes for instance by strong compressed-air jets of a compressed-air defoliator are reduced, since the outer leaves have already been removed and can therefore no longer strike the fruit like “projectiles”.

Therefore, when two such defoliating units with different modes of action are used, surprisingly much more gentle defoliation takes place than in cases in which only one defoliator with one mode of operation is used. In the case of the apparatus according to the invention, the leaves that previously shielded the bunches of fruit have already been removed by the suction-air defoliator before the compressed-air defoliation, and so the latter can also remove remnants of flowers on the fruits, on which moisture collects, which can result in decay. Furthermore, it is thus possible for the pressure of the compressed-air defoliator to be reduced for the same result, and so a large amount of compressor power is saved. Even in initial tests, the same defoliation results for this mode of action were achieved in spite of a reduction in the pressure by 30%.

A further advantage only becomes apparent with more comprehensive consideration. Defoliating apparatuses are usually arranged on booms or supporting arms of special tractors and mounted on the booms such that the devices can be positioned appropriately with respect to the plant to be defoliated. The combination according to the invention of defoliating units within an apparatus now also means that the tractor only has to travel through a row of plants only once for two different treatment operations or processes. The ground is thus compacted much less by the very heavy working device and absorption capacity for water is reduced less; interim or subsequent loosening of the ground is often no longer necessary at all.

Moreover, when the apparatus according to the invention having defoliating units with different modes of action is used, the advantage of a reduced working time is also clearly apparent. While a working speed of up to 5 km/h is achievable with the respectively separate operation of a roll or roller defoliator, and up to 2.5 km/h is achievable with a compressed-air defoliator, the defoliating apparatus according to the invention having two defoliating units achieves a working speed of up to 7 km/h.

In a particularly advantageous development, the front surface of the plate is provided, in the region of the working opening for the second defoliating unit in the working direction, with a setback with respect to the front surface in the region of the working opening for the first defoliating unit in the working direction, such that the respective surface regions have an offset with respect to the plant region to be defoliated. Thus, the second defoliating unit is at a greater distance from the plant region to be defoliated than the first defoliating unit. This offset provided according to the invention is, among other things, essential for the synergistic action of the two units.

This is because, in the case of a suction-air defoliator, usually in the form of a roller defoliator/roll defoliator, it is generally important that the rollers sweep past as close as possible to the “canopy”, that is to say are guided as close as possible to the leaves to be removed. It is then possible for a high volumetric flow, generated for example by a relatively simple radial compressor, with a comparatively low suction pressure to be enough, with the small effective distance, to draw larger and a large quantity of leaves into the gap between the two rollers rotating in opposite directions, such that the leaves are then plucked by the rotating rollers.

This mode of operation is basically the same for all roller defoliators, whether air is drawn in through a perforated roller or the air is drawn directly through the roller gap. The working opening or cutout belonging to the roller defoliator/roll defoliator corresponds to the roller height and is configured in terms of its width such that the tangent at the front surface of the plate forms for instance the tangent to the roller surface and thus the leaves can be drawn in and plucked. The plucked leaves are transported rearwardly further into and through the roller defoliator by the airflow and blown out or ejected via the rotating rollers.

In the case of the compressed-air defoliator, in which, given a comparatively low volumetric flow, a relatively high pressure is generated, it has proven advantageous, by contrast, when, as a result of the arrangement according to the invention and the offset, the plant does not come into contact with rotating parts or with the powerful compressed-air pulses directly at the nozzle. As a result of the rearward offset and the resultant greater distance of the nozzle outlet openings, it is also possible for the jet cross section or jet cone of the pulsed compressed-air jets emitted toward the plant to already expand/increase in size somewhat before reaching the plant. Although the pressure pulse is thus still effective, it can damage the plant less. This is because, in the case of the compressed-air defoliator, a relatively high pressure is generated with a comparatively low volumetric flow.

The offset or the setback in the front surface of the plate thus brings about defoliation that is as low-stress as possible for the plant, with two defoliating units that have complementary actions. Likewise, the offset has the effect that the plant is in more or less close contact with the apparatus for a shorter time, specifically only over about half the working length, and so the mechanical stress on the plant is kept low overall. The risk of plant parts passing into rotating devices of the compressed-air defoliator is likewise reduced.

In a further advantageous configuration, the plate is formed in one piece and the setback is in the form of a rearwardly inclined slope or curve, connecting the respective surface regions and bridging the offset, in the front surface of the plate. Such a “gentle” transition in the formation of the front of the shield is not only easy to produce but also helps to prevent plant parts from springing back or being knocked back abruptly onto the following rotating nozzle devices.

In a further advantageous configuration, the plate is formed in a multipart manner such that the offset between the surface regions and thus the setback is settable manually or by a motor, wherein the offset or setback is preferably able to be covered by a flexible front surface part of the plate. With such a configuration, the height of the setback or offset is settable with respect to the foliage to be treated in each case of the plants. The flexible covering of the offset again brings about the above-described gentle transition in the front surface of the plate between the working openings of the roller defoliator and compressed-air defoliator.

In a further advantageous configuration, the front surface of the plate is inclined in the region of the setback at an angle of less than 90° to the surface normal. Such a shallow inclination likewise acts as a smooth, gentle transition.

In a further advantageous configuration, the plate is pivotable about a vertical and/or a horizontal axis, preferably with respect to the boom carrying the defoliating apparatus and/or with respect to the canopy to be treated. Thus, it is possible for sloping canopies, for instance those that have been cut to be inclined extensively toward the sunny side, to be treated gently in a simple manner.

In a further advantageous configuration, the first defoliating unit in the working direction is in the form of a roller defoliator with rollers that are drivable in opposite directions, and the second defoliating unit in the working direction is in the form of a compressed-air defoliator with rotating compressed-air jets directed at the plant regions to be defoliated, preferably with pulsed compressed-air jets, wherein the compressed-air jets, emerging from nozzles of a nozzle arrangement that is drivable in rotation, rotate on a circular path, the diameter of which corresponds substantially to the effective working height of the rollers that are drivable in opposite directions and thus to the height of the associated working opening or cutout for the roller defoliator.

Compressed-air defoliators formed in such a way with rotating compressed-air jets directed at the plant regions to be defoliated sweep, with a relatively simple design, over the entire working area, that is to say the entire working height defined by the working openings in the plate, multiple times depending on their rotational speed and thus provide reliable and very effective “second” defoliation.

In a further advantageous configuration, the first defoliating unit in the working direction is in the form of a roller defoliator with rollers that are drivable in opposite directions, and the second defoliating unit in the working direction is in the form of a compressed-air defoliator with a plurality of rotating compressed-air jets directed at the plant regions to be defoliated, preferably with pulsed compressed-air jets, wherein the compressed-air jets, emerging from nozzles of at least two nozzle arrangements that are drivable in rotation, rotate on a plurality of circular paths, the diameters of which are smaller than the height of the working opening or cutout, formed in the plate, for the roller defoliator. The common effective working height of the plurality of rotating compressed-air jets corresponds in this case to the working height of the rollers that are drivable in opposite directions and thus to the height of the associated working opening or cutout for the roller defoliator.

Rather than a single rotating nozzle arrangement, the nozzles of which rotate on a large circular path, in this case a plurality of smaller rotating nozzle arrangements, for example two or three smaller rotors with nozzles are arranged one above another at smaller diameters. This results in particularly uniform compressed-air action on the plant, this advantageously supporting the gentle treatment during defoliation. Additionally, this results in smaller distances between the active regions of the compressed-air jets in which compressed-air pulses strike the plant, and thus more frequent overlapping of the compressed-air cones.

In a further configuration that has an advantageous effect in the scope of gentle treatment, the outlet cross section or nozzle opening diameter of the respective nozzles belonging to the nozzle arrangements that are drivable in rotation is adjustable, for instance in terms of its size or of its inclination/direction.

In a further advantageous configuration, guide elements for plant parts are provided on the front surface of the plate, preferably guide rails or bars extending in the working direction. Such guide elements, for instance in the form of guide bars which are arranged on the upper and lower edge of the plate and project beyond the front surface of the shield serve to delimit and to define the plant region to be defoliated, specifically in that they prevent the plant parts from being bent, blasted or broken by the air flows of the two defoliating units.

In a further advantageous configuration, the suction-air defoliator arranged on the rear of the common plate is configured such that its suction airflow is settable or pivotable, preferably able to be inclined forward in relation to the working direction. The intake flow of the suction-air defoliator is inclined forward slightly in the working direction/direction of travel such that, among other things, the compressed-air pulses of the compressed-air defoliator are influenced as little as possible by the intake flow of the suction-air defoliator/roller defoliator. Furthermore, an intake region inclined forwardly in the working direction can allow a higher working speed.

In a further advantageous configuration, the defoliating units arranged on the rear of the common plate are connected to the plate so as to be pivotable and/or releasable or are articulated thereto. Such a configuration allows easy maintenance and cleaning of the defoliating units and, after the units have been released and/or swung back, allows rear access to the corresponding working openings in the plate, which can thus likewise be easily cleaned.

In an advantageous method for operating a defoliating apparatus according to the invention, the suction airflow of the suction-air defoliator is used at least partially to cool components of the compressed-air defoliator or to cool a vehicle carrying the defoliating apparatus, preferably of course after the leaf remnants entrained in the airflow have been separated therefrom.

In a further method for operating a defoliating apparatus according to the invention, which is advantageous because it saves energy, a central air supply is used to generate compressed air for the compressed-air defoliator and suction air for the suction-air defoliator.

### BRIEF DESCRIPTION OF THE DRAWINGS

The invention will be explained in more detail on the basis of an exemplary embodiment. In the drawings:

FIG. 1 shows the use of the apparatus according to the invention on the boom of a tractor in the form of a basic illustration,

FIG. 2 shows the defoliating apparatus according to the invention in a view from its side facing the canopy or the surface to be defoliated,

FIG. 3 shows the defoliating apparatus illustrated in FIG. 2 in an enlarged perspective view,

FIG. 4 shows a rear view of the defoliating apparatus illustrated in FIG. 2 with the defoliating units arranged on the rear of the common plate,

FIG. 5 shows the defoliating units, arranged pivotably on the rear of the common plate, of the defoliating apparatus according to the invention.

### DETAILED DESCRIPTION

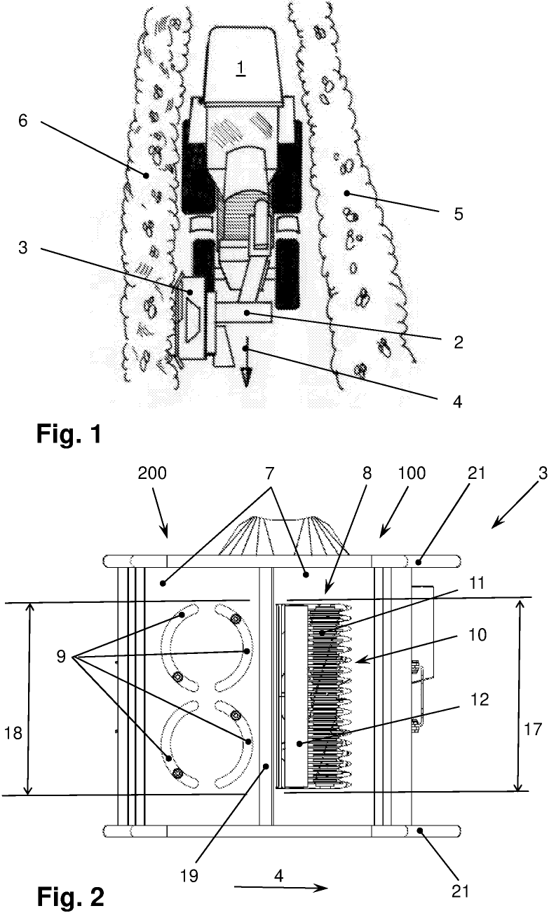

FIG. 1 outlines the use of the apparatus according to the invention in the form of a basic illustration. The outline shows a tractor 1 as seen obliquely from the front and above, which carries a defoliating apparatus 3 according to the invention on a boom 2 located on its front side and moves in the direction of travel 4 in a vineyard between two rows of vines 5, 6. The direction of travel 4 of the tractor 1 is thus identical to the working direction of the defoliating apparatus 3.

FIG. 2 shows the defoliating apparatus 3 according to the invention in a more detailed illustrated in a view from its side facing the canopy or the surface to be defoliated. Specifically, FIG. 2 shows the front surface of a plate 7 of the defoliating apparatus, on the rear of which a plurality of defoliating units are arranged. The plate 7 is provided with working openings or cutouts 8, 9, through which the defoliating units arranged on the rear act on the plant, while the defoliating apparatus 3 as a whole moves in the working direction 4 past the plant, i.e. in this case past the face to be defoliated of the row of vines 6.

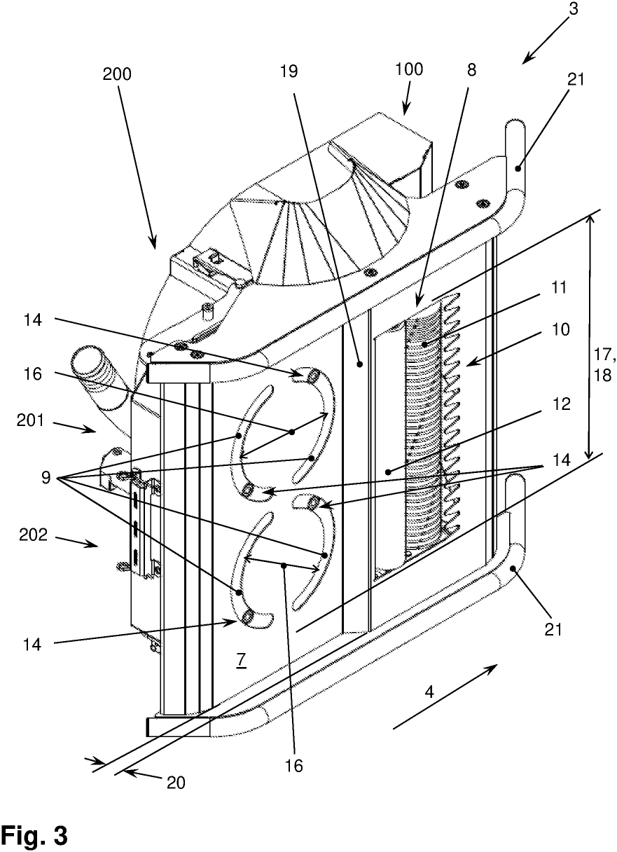

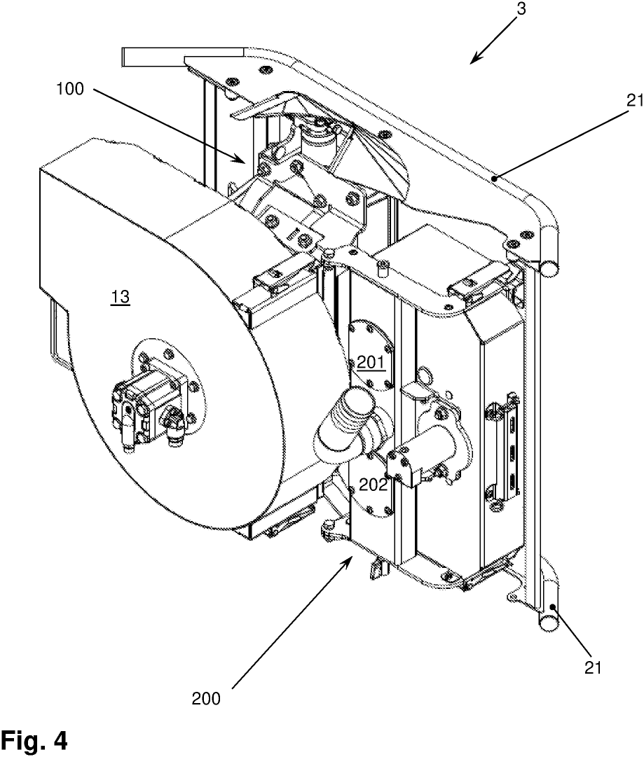

As is already apparent from FIG. 2 in the form of the working openings 8 and 9, but more clearly visible when viewed together with FIGS. 3 and 4, the defoliating units 100 and 200, respectively, arranged in succession act on the plant both sequentially, that is to say one after another, and in different ways for defoliation. In this regard, FIG. 3 shows the defoliating apparatus illustrated in FIG. 2 in an enlarged perspective view, and FIG. 4 shows the associated detailed rear view.

The working opening 8 is in this case substantially rectangular, wherein its front edge 10 in the working direction is cut out in a zigzag shape and thus adapted approximately to a fluted roller 11. The first defoliating unit in the direction of travel or working direction 4 is in this case specifically in the form of a roll or roller defoliator 100 with two rollers 11 and 12 rotating in opposite directions, wherein a fluted roller 11 is arranged parallel to a counterpart roller 12 with a gap in between. A fan that is in the form of a radial compressor 13 and is arranged behind the rollers, see FIG. 4, draws leaves into the gap, the leaves then being plucked by the rotating rollers. As already stated at the beginning in relation to the prior art, the roller defoliator/roll defoliator 100 is known per se and therefore not described in more detail here.

The working opening or cutout 8 belonging to the roller defoliator/roll defoliator 100 corresponds to the roller height and is configured in terms of its width such that the tangent at the front surface of the plate forms for instance the tangent to the roller surfaces and thus the leaves can be drawn in at the plate surface and plucked. The plucked leaves are transported rearwardly further into and through the roller defoliator by the airflow and transported and blown out by the radial compressor 13.

In the embodiment of the defoliating apparatus according to the invention that is described here, the second defoliating unit 200 in the direction of travel or working direction 4 is in the form of a double unit and consists of two compressed-air defoliators 201, 202, arranged one above the other, with a plurality of rotating compressed-air jets directed at the plant regions to be defoliated, in this case with pulsed compressed-air jets. This becomes clear from viewing FIGS. 2 to 4 together.

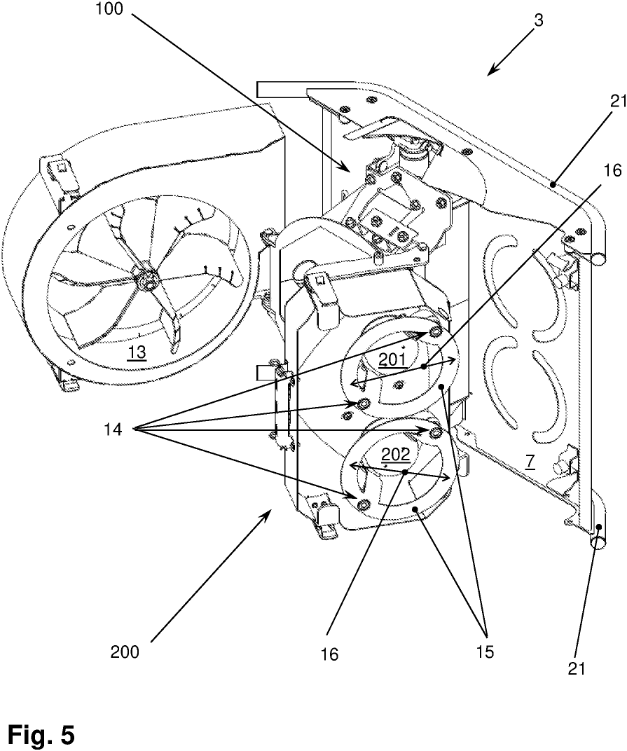

The compressed-air jets in this case emerge from nozzles 14 of two nozzle arrangements 15 that are drivable in rotation (FIG. 5), and rotate on two circular paths, the diameters of which 16 are smaller than the height 17 of the working opening 8, formed in the plate, for the roller defoliator. The common effective working height 18 of the plurality of rotating compressed-air jets corresponds to the working height of the rollers that are drivable in opposite directions and thus to the height 17 of the associated working opening 8 for the roller defoliator. The working openings 9 are in this case in the form of annular opening slots, forming a part-circle, for the rotating compressed-air jets, and the diameter of the respective opening slots corresponds to the diameter 16 of the circular path on which the respectively associated outlet nozzles 14 rotate.

As likewise already stated, compressed-gas defoliators having rotating compressed-gas jets are likewise known per se, and so the two double units 201 and 202 are not described in more detail here either.

The defoliating units 100 and 200, i.e. 201 and 202, arranged in succession in the working direction and direction of travel 4 and behind the working opening 8 and the working openings 9, respectively, in the plate 7, thus act sequentially, i.e. one after another, on the plant region to be defoliated, as becomes clear when viewed together with FIG. 1. First of all, defoliation is carried out by the roller defoliator 100, and then defoliation is carried out by the two compressed-air defoliators 201 and 202. As a result, the embodiment, described here, of the defoliating apparatus according to the invention having its two defoliating units 100 and 200 with different modes of action allows exceptionally more gentle defoliation.

A particularly important expression of the embodiment, described here, of the embodiment according to the invention of the defoliation apparatus is clearly apparent both from FIG. 3 and from FIG. 2. The front surface of the plate 7, i.e. the surface thereof facing the plant, is provided, in the region of the working openings 9 for the second defoliating unit 200 in the working direction, with a setback 19 with respect to the front surface in the region of the working opening 8 for the first defoliating unit 100 in the working direction, such that the respective surface regions have an offset 20 with respect to the plant region to be defoliated.

The plate 7 is in this case formed in one piece, wherein the setback 19 is in the form of a rearwardly inclined slope, connecting the respective surface regions and bridging the offset, in the front surface of the plate.

As already illustrated comprehensively above, this offset 20 or the setback 19 in the front surface of the plate 7, in combination with the remaining features, is crucial for defoliation that is as low-stress as possible for the plant, with two defoliating units that have complementary actions. Likewise, the offset has the effect that the plant is in more or less close contact with the apparatus for a shorter time, specifically over about half the working length, and so the mechanical stress on the plant is kept low overall.

Provided on this front surface of the plate 7 are guide elements for plant parts, in the form, in this embodiment, of guide bars 21, extending in the working direction, on the upper and lower edge of the plate The guide bars are sloped in a set-back manner on the inlet side and outlet side.

FIG. 5 shows yet another advantageous design of the embodiment presented here, specifically a configuration in which the defoliating units 100 and 200, or 201 and 202, arranged on the rear of a common plate 7 are connected pivotably to the plate 7 via hinges and articulated connections, not described specifically here, such that, by folding open the unit parts or after releasing and/or swinging back the units, as shown here in FIG. 5, easy maintenance and cleaning of the defoliating units and rear access to the corresponding working openings becomes possible.

### LIST OF REFERENCE SIGNS

Part of the description

| | |
|---|---|
| 1 | Tractor |
| 2 | Boom |
| 3 | Defoliating apparatus |
| 4 | Direction of travel, working direction |
| 5 | Row of vines |
| 6 | Row of vines |
| 7 | Plate |
| 8 | Working opening in roller defoliator |
| 9 | Working opening in compressed-air defoliator |
| 10 | Front, toothed edge of the working opening 8 |
| 11 | Fluted roller |
| 12 | Counterpart roller |
| 13 | Radial fan |
| 14 | Nozzle |
| 15 | Nozzle arrangement |
| 16 | Circular-path diameter |
| 17 | Height of working opening in roller defoliator |
| 18 | Effective working height of compressed-air defoliator |
| 19 | Setback |
| 20 | Offset |
| 21 | Guide bar |
| 100 | Defoliating unit, roller defoliator |
| 200 | Defoliating unit, compressed-air defoliator |
| 201 | Defoliating unit, double unit 1 |
| 202 | Defoliating unit, double unit 2 |

1. A defoliating apparatus comprising:
at least two defoliating units which are arranged on the rear of a common plate of the apparatus, the front surface of which faces a plant to be defoliated, wherein the plate is provided with working openings or cutouts through which the defoliating units, arranged on the rear, act on the plant, wherein the defoliating apparatus is movable in a working direction past the plant, and wherein in each case two defoliating units with different modes of action are arranged in succession in the working direction such that they act sequentially on the plant region to be defoliated.

2. The defoliating apparatus as claimed in claim 1, wherein the first, in the working direction, of the two defoliating units arranged in succession is in the form of a suction-air defoliator and the second, in the working direction, of the two defoliating units arranged in succession is in the form of a compressed-air defoliator.

3. The defoliating apparatus as claimed in claim 1, wherein the front surface of the plate is provided, in the region of the working opening for the second defoliating unit in the working direction, with a setback with respect to the front surface in the region of the working opening for the first defoliating unit in the working direction, such that the respective surface regions have an offset with respect to the plant region to be defoliated.

4. The defoliating apparatus as claimed in claim 3, wherein the plate is formed in one piece and the setback is in the form of a rearwardly inclined slope or curve, connecting the respective surface regions and bridging the offset, in the front surface of the plate.

5. The defoliating apparatus as claimed in claim 3, wherein the plate is formed in a multipart manner such that the offset between the surface regions and thus the setback is settable manually or by a motor, wherein the offset is preferably able to be covered by a flexible front surface part of the plate.

6. The defoliating apparatus as claimed in claim 1, wherein the front surface of the plate is inclined in the region of the setback at an angle of less than 90° to the surface normal.

7. The defoliating apparatus as claimed in claim 1, wherein the plate is pivotable about a vertical and/or a horizontal axis.

8. The defoliating apparatus as claimed in claim 1, wherein the first defoliating unit in the working direction is in the form of a roller defoliator with rollers that are drivable in opposite directions, and the second defoliating unit in the working direction is in the form of a compressed-air defoliator with rotating compressed-air jets directed at the plant regions to be defoliated, preferably with pulsed compressed-air jets, wherein the compressed-air jets, emerging from nozzles of a nozzle arrangement that is drivable in rotation, rotate on a circular path, the diameter of which corresponds substantially to the effective working height of the rollers that are drivable in opposite directions and thus to the height of the associated working opening or cutout for the roller defoliator.

9. The defoliating apparatus as claimed in claim 1, wherein the first defoliating unit in the working direction is in the form of a roller defoliator with rollers that are drivable in opposite directions, and the second defoliating unit in the working direction is in the form of a compressed-air defoliator with a plurality of rotating compressed-air jets directed at the plant regions to be defoliated, preferably with pulsed compressed-air jets, wherein the compressed-air jets, emerging from nozzles of at least two nozzle arrangements that are drivable in rotation, rotate on a plurality of circular paths, the diameters of which are smaller than the height of the working opening or cutout, formed in the plate, for the roller defoliator, and wherein the common effective working height of the plurality of rotating compressed-air jets corresponds to the working height of the rollers that are drivable in opposite directions and thus to the height of the associated working opening or cutout for the roller defoliator.

10. The defoliating apparatus as claimed in claim 8, wherein the outlet cross section of the nozzles belonging to the nozzle arrangements that are drivable in rotation is adjustable.

11. The defoliating apparatus as claimed in claim 1, wherein guide elements for plant parts are provided on the front surface of the plate, preferably guide rails or bars extending in the working direction.

12. The defoliating apparatus as claimed in claim 2, wherein the suction-air defoliator arranged on the rear of the common plate is configured such that its suction airflow is settable or pivotable, preferably able to be inclined forward in relation to the working direction .

13. The defoliating apparatus as claimed in claim 1, wherein the defoliating units arranged on the rear of a common plate are connected to the plate so as to be pivotable and/or releasable.

14. A method for operating a defoliating apparatus as claimed in claim 2, wherein the suction airflow of the suction-air defoliator is used at least partially to cool components of the compressed-air defoliator or to cool a vehicle carrying the defoliating apparatus.

15. A method for operating a defoliating apparatus as claimed in claim 2, wherein a central air supply is used to generate compressed air for the compressed-air defoliator and suction air for the suction-air defoliator.
